(19) United States
(12) Patent Application Publication
(10) Pub. No.: US 2026/0328031 A1
(43) Pub. Date: Oct. 22, 2026

(54) Door Hinge and Method

(71) Applicants: Stephen Fields, Palm Desert, CA (US); Aaron Fields, Palm Desert, CA (US)

(72) Inventors: Stephen Fields, Palm Desert, CA (US); Aaron Fields, Palm Desert, CA (US)

(21) Appl. No.: 19/185,157

(22) Filed: Apr. 21, 2025

(51) Int. Cl. E05D 5/04; E05D 3/02; E05D 11/00

(52) U.S. Cl. CPC E05D 5/04; E05D 3/02; E05D 11/0054

(57) ABSTRACT

A door hinge includes a door flange. The door flange includes a first-cylindrical portion. The first-cylindrical portion segmented and having an axially vectored borehole therethrough. The door hinge includes a frame flange. The frame flange including a second-cylindrical portion. The second-cylindrical portion segmented and having a corresponding axially vectored borehole therethrough. The first-cylindrical portion and second-cylindrical portion are configured to engage when their respective boreholes are coaxial. A plurality of apertures are disposed on the door flange and the frame flange. A plurality of plugs are included with the door hinge. Each of the plurality of plugs are sized and dimensioned to close at least one of the plurality of apertures. The door hinge is useful for attaching a door to a door frame

### CROSS-REFERENCE TO RELATED APPLICATION(S)

This Application is a Continuation in Part Application to U.S. patent application Ser. No. 16/242,763 filed on Jan. 8, 2019, which is related to and claims priority to U.S. Provisional Patent Application No. 62/621,488 filed Jan. 24, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of housing fixtures of existing art and more specifically relates to door hinges.

### RELATED ART

Traditional door hinge assemblies include a door hinge that is used to mount a door to a door frame. Presently, door hinge assemblies use a uniform array of mounting apertures that accept fasteners. The mounting apertures are typically uniformly distributed and in the same location, despite the varying manufactures of the door hinges. A common issue with existing door hinge art arises with the repeated use of a mounting surface. The mounting surface is typically wood, in which an aperture is created that aligns with the mounting aperture of the door hinge. Following repeated use with conventional door hinges, the aperture created in the mounting surface must be reprocessed to secure mounting fasteners. A suitable solution is desired.

U.S. Pat. No. 7,162,774 to Julius von Resch relates to a multi-position adjustable door hinge. The described multi-position adjustable door hinge is comprised of a frame leaf having a lower barrel section and a door leaf having an upper barrel section. An eccentric pivot pin is disposed in axial rotational fit in a through bore of the lower barrel section and is in contact at a lower end with an adjustment screw. The eccentric pivot pin has an upper cylindrical portion eccentrically displaced from the lower cylindrical portion and extends into a cylindrical bore of an eccentric compensator cylinder adjustably retained in the through bore of the upper barrel section. The eccentric pivot pin and the eccentric compensator cylinder are both axially displaceable from one another whereby to impart relative lateral displacement thereof and of the barrels to a desired position. The adjustment screw at the bottom of the lower barrel section provides vertical adjustment between the frame leaf and the door leaf. Set screws are provided to lock the eccentric pivot pin and the eccentric compensator cylinder at the desired position.

### SUMMARY OF THE INVENTION

In view of the foregoing disadvantages inherent in the known door hinge art, the present disclosure provides a novel door hinge. The general purpose of the present disclosure, which will be described subsequently in greater detail, is to provide an effective and efficient door hinge.

A door hinge is disclosed herein. The door hinge includes a door flange. The door flange includes a first-cylindrical portion. The first-cylindrical portion is segmented and having an axially vectored borehole therethrough. The door hinge includes a frame flange. The frame flange includes a second-cylindrical portion. The second-cylindrical portion is segmented and has a corresponding axially vectored borehole therethrough. The first-cylindrical portion and second-cylindrical portion are configured to engage when their respective boreholes are coaxial. A plurality of apertures are disposed on the door flange and the frame flange. A plurality of plugs are included with the door hinge. Each of the plurality of plugs are sized and dimensioned to couple with and close at least one of the plurality of apertures.

The present invention provides a standard sized hinge with multiple hole patterns. The multiple hole patterns allow for a door to be reattached to a frame that has been previously used by a conventional door hinge. The hinge of the present invention provides multiple fastener hole options for the installation of a door to a door frame. The fastener holes may be in an arbitrary arrangement or placed in locations that have not previously been used. The immediate innovation of the disclosed door hinge further includes multiple plugs for the arrangement of holes. The plugs may be inserted into unused fastener holes at design preference of the user. Ultimately, the disclosed door hinge provides a means to refasten doors to door frames.

According to another embodiment, a method of installing a door hinge is also disclosed herein. The method of installing a door hinge includes providing a door hinge as describe above; aligning the door hinge with respective mortises on a frame and a door; fastening the door hinge to the frame and the door with fasteners through a corresponding set of a plurality of apertures and lastly, an optional step of inserting plugs into the plurality of apertures.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a door hinge and method, constructed and operative according to the teachings of the present disclosure.

FIG. 1 is a perspective view of the door hinge according to an embodiment of the disclosure.

FIG. 2 is a top view of the door hinge of FIG. 1, according to an embodiment of the present disclosure.

FIG. 3 is a side view of the door hinge of FIG. 1, according to an embodiment of the present disclosure.

FIG. 4 is a side view of the door hinge of FIG. 1, according to an embodiment of the present disclosure.

FIG. 5 is a flow diagram illustrating a method of installing a door hinge, according to an embodiment of the present disclosure.

FIG. 6 depicts the door hinge herein configured for positioning on a door and frame which includes plugs which screw into unused apertures from a rear side of the door hinges, during the mounting process.

FIG. 7 shows a rear view of a door hinge of the system herein, wherein the apertures are configured with recesses adjacent the rear surface of at least one and preferably both of the components forming the door hinge and an enlarged view of plugs having annular projections at the second end thereof which are configured to snap into and out of the recesses.

FIG. 8 depicts the door hinge of the system herein wherein the plugs are magnetically attractive to the metal forming the door flange and the frame flange of the door hinge and are easily inserted into unused apertures.

FIG. 9 shows and end view of the plugs of FIG. 8 adjacent apertures for insertion therein.

FIG. 10 depicts the door hinge herein and dowels which are sized for insertion into unused apertures for a frictional fit therein, and which may project into the unused hole or a new hole in a door or frame for stability.

FIG. 11 shows an aperture determination and alignment card which has a perimeter edge matching that of the hinge which is provided with the card and a plurality of holes which align with the apertures of the provided door hinge.

The various embodiments of the present invention will hereinafter be described in conjunction with the appended drawings, wherein like designations denote like elements.

### DETAILED DESCRIPTION

As discussed above, embodiments of the present disclosure relate to a door fixture and more particularly to a door hinge and method as used to improve the existing door hinge art.

Generally, the door hinge kit of the present invention is designed to allow the average homeowner to quickly rehang loose doors without the need to hire a carpenter to reroute new holes. It offers a door hinge with multiple hole patterns and matching hole plugs of the same material. The device effectively eliminates the need to reroute because of damaged holes in the doorjamb and door. It prevents future costs of replacing door hinges and casings and other expensive repairs. The present invention affords specifically designed plates with openings for a versatile fit regardless of door size.

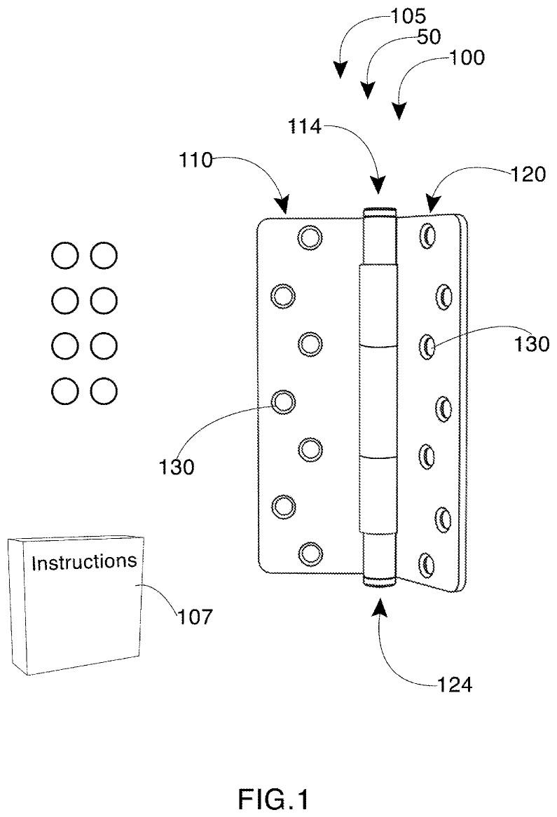

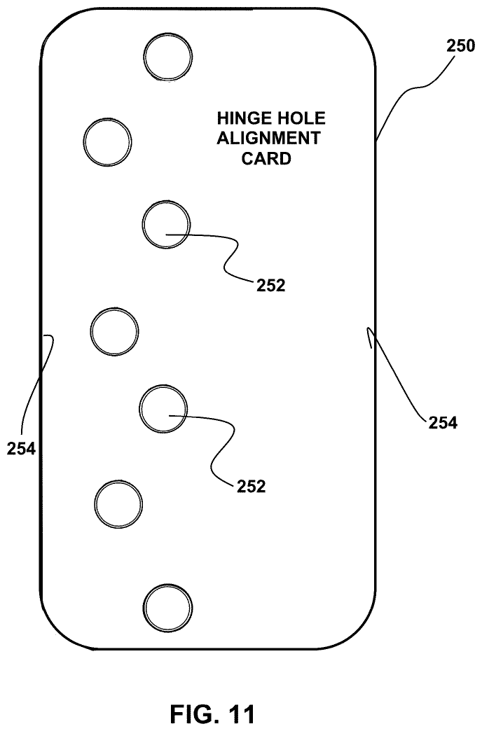

Referring now more specifically to the drawings by numerals of reference, there is shown in FIGS. 1-11, various views of a door hinge 100.

FIG. 1 shows a door hinge 100 during an ‘in-use’ condition 50, according to an embodiment of the present disclosure. Here, the door hinge 100 may be beneficial to attach a door to a frame. As illustrated, the door hinge 100 may include a door flange 110 which as shown is axially engaged with a frame flange 120. Both the door flange 110 and the frame flange 120 have a plurality of apertures 130 which will couple with a plurality of plugs 140.

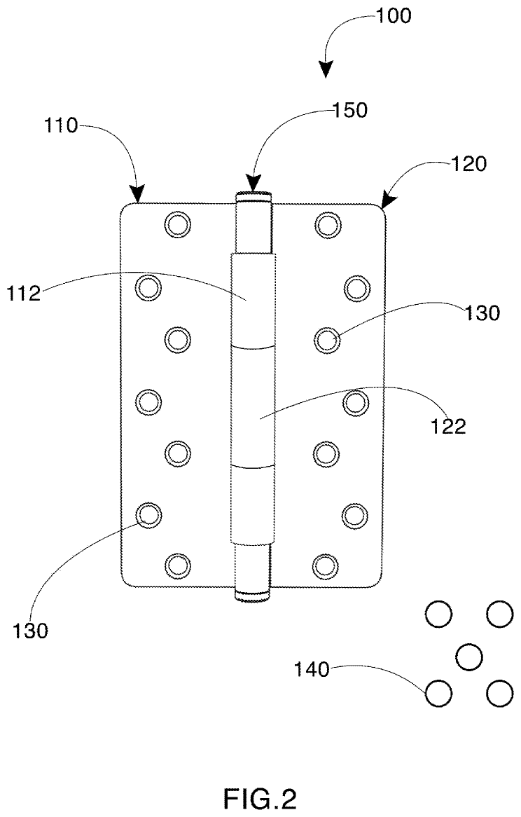

The door flange 110 includes a first-cylindrical portion 112 (FIG. 2). The first-cylindrical portion 112 is segmented and has an axially vectored borehole 114 therethrough. In some embodiments, the first-cylindrical portion 112 comprises greater than three segments. The frame flange 120 includes a second-cylindrical portion 122 (FIG. 2). The second-cylindrical portion 122 is segmented and has a corresponding axially vectored borehole 124 therethrough. In some embodiments, the second-cylindrical portion 122 comprises greater than three segments. The first-cylindrical portion 112 and the second-cylindrical portion 122 are configured to engage with a pin to provide an a pivoting or axial engagement when their respective boreholes are coaxial. The plurality of apertures 130 are disposed on the door flange 110 and the frame flange 120. The plurality of plugs 140 are sized and dimensioned to close at least one of the plurality of apertures 130.

According to one embodiment, the door hinge 100 may be arranged as a kit 105. In particular, the door hinge 100 may further include a set of instructions 107. The instructions 107 may detail functional relationships in relation to the structure of the door hinge 100 such that the door hinge 100 can be used, maintained, or the like, in a preferred manner.

FIG. 2 shows the door hinge 100 of FIG. 1, according to an embodiment of the present disclosure. As above, the door hinge 100 may include a door flange 110, a frame flange 120, a plurality of apertures 130, and a plurality of plugs 140. The door hinge may further comprise a pin 150. The pin 150 may be sized to fit in the boreholes. The pin 150 may pass through the first-cylindrical portion 112 and the second-cylindrical portion 122 when their respective boreholes are coaxial. The pin 150 may be uniformly cylindric in shape, having an outer diameter similarly sized to the inner diameter of the first-cylindrical portion 112 and the second-cylindrical portion 122. The pin 150 may be configured to provide a pivoting engagement and rotation between the door flange 110 and the frame flange 120. The pin 150 may be configured with any conceived structure that provides functional relationship between the door flange 110 and the frame flange 120.

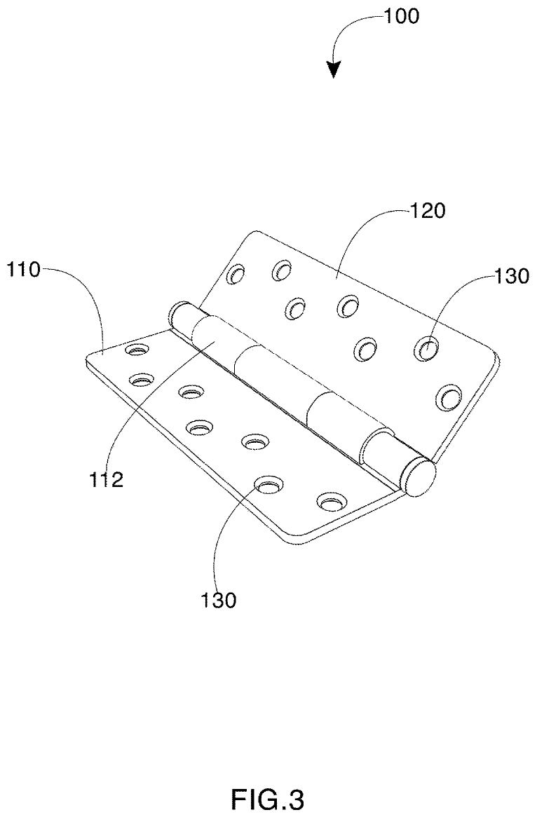

FIG. 3 is another view of the door hinge 100 of FIG. 1, according to an embodiment of the present disclosure. As illustrated, the door hinge 100 may include a door flange 110, a frame flange 120, a plurality of apertures 130, and a plurality of plugs 140 (FIG. 1). The door flange 110 includes a first-cylindrical portion 112. The first-cylindrical portion 112 is segmented and has an axially vectored borehole 114 (FIG. 1) therethrough. The frame flange 120 includes a second-cylindrical portion 122. The second-cylindrical portion 122 is segmented and has a corresponding axially vectored borehole 124 (FIG. 1) therethrough. The first-cylindrical portion 112 and the second-cylindrical portion 122 are configured to engage when their respective boreholes are coaxial. The plurality of apertures 130 are disposed on the door flange 110 and the frame flange 120. The plurality of apertures 130 are sized to receive screw fasteners. The screw fasteners may be screws, nails, bolts, and other applicable fasteners used to secure the door hinge 100 in a static position. The plurality of apertures 130 may include countersinks. The countersink may be sized to receive one of the plurality of plugs 140.

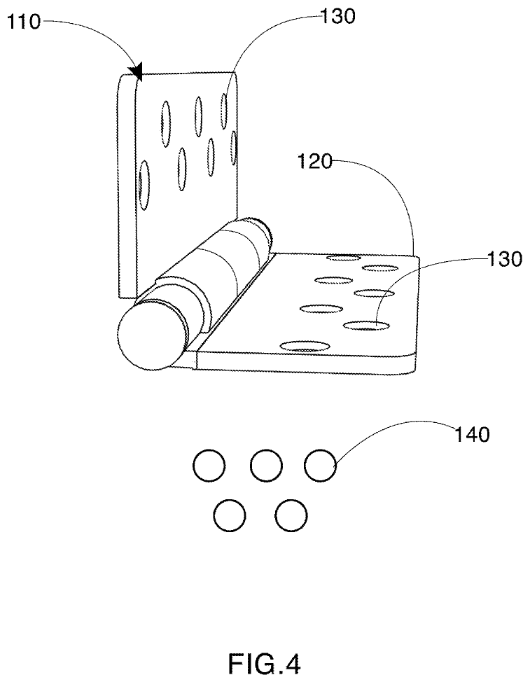

FIG. 4 is another view of the door hinge 100 of FIG. 1, according to an embodiment of the present disclosure. As above, the door hinge 100 may include a door flange 110, a frame flange 120, a plurality of apertures 130, and a plurality of plugs 140. The door flange 110 includes a first-cylindrical portion 112 (FIG. 2). The first-cylindrical portion 112 is disposed on at least one peripheral edge of the door flange 110. The first-cylindrical portion 112 is segmented and has an axially vectored borehole 114 (FIG. 1) therethrough. The frame flange 120 includes a second-cylindrical portion 122. The second second-cylindrical portion 122 is disposed on at least one peripheral edge of the frame flange 120. The second-cylindrical portion 122 is segmented and has a corresponding axially vectored borehole 124 therethrough. The door flange 110 may comprise metal. The frame flange 120 may comprise metal. Other rigid materials including plastics and metal composite materials may be considered.

The immediate innovation of the door hinge 100 may be the plurality of apertures 130 disposed on the door flange 110 and the frame flange 120. The plurality of apertures 130 may be disposed arbitrarily on the door flange 110 and the frame flange 120. In another embodiment, the plurality of apertures 130 may be disposed in a pattern. In some embodiments, the plurality of apertures 130 may be greater than four. The number of apertures 130 and their location on the door flange 110 and the frame flange 120 increase the mounting functionality of the door hinge 100 (FIG. 1). Each of the plurality of apertures 130 is coupled with at least one of the plurality of plugs 140. Each of the plurality of plugs 140 are configured to couple with and close each of the plurality of apertures 130. The plurality of plugs 140 may comprise a metal. The plurality of plugs 140 may comprise a plastic. The composition of the plugs 140 may be subject to manufacturing, and user preference.

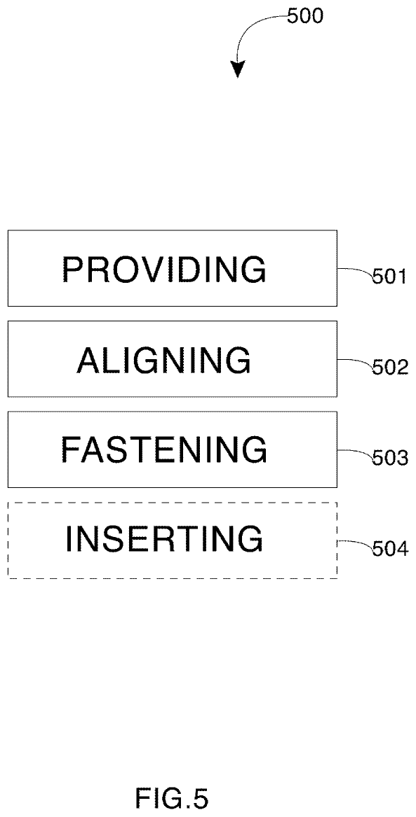

FIG. 5 is a flow diagram illustrating a method for installing 500 a door hinge 100, according to an embodiment of the present disclosure. In particular, the method for installing 500 a door hinge 100 may include one or more components or features of the door hinge 100 as described above. As illustrated, the method for installing 500 a door hinge 100 may include the steps of: step one 501, providing a door hinge comprising a door flange, the door flange including a first-cylindrical portion, the first-cylindrical portion segmented and having an axially vectored borehole therethrough; a frame flange, the frame flange including a second-cylindrical portion, the second-cylindrical portion segmented and having a corresponding axially vectored borehole therethrough, the first-cylindrical portion and second-cylindrical portion configured to engage when their respective boreholes are coaxial; a plurality of apertures, the plurality of apertures disposed on the door flange and the frame flange; and, a plurality of plugs, each of the plurality of plugs are sized and dimensioned to close at least one of the plurality of apertures; step two 502, aligning the door hinge with respective mortises on a frame and a door; step three 503, fastening the door hinge to the frame and the door with fasteners through a corresponding set of a plurality of apertures; step four 504, inserting plugs into the plurality of apertures.

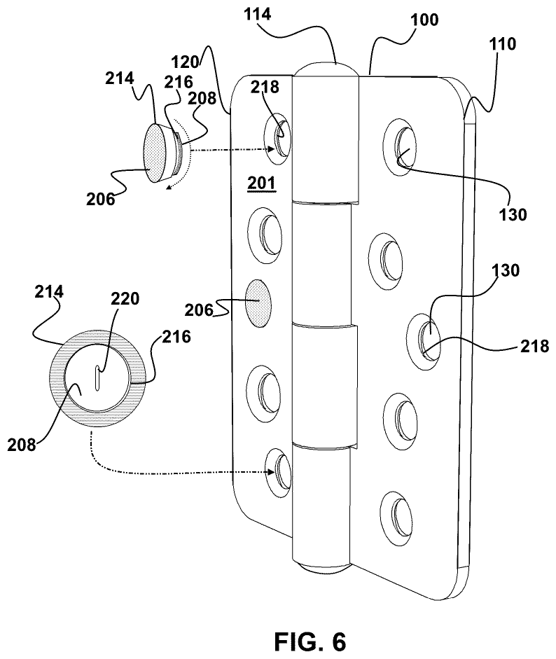

In FIG. 6 is shown the door hinge 100 of the system herein configured for positioning on a door and frame which includes plugs 214 which form a coupled engagement with the apertures 130 of one or both of the door flange 110 or the frame flange 120. In the depiction of FIG. 6, the coupling engagement is provided by plug threads 216 which threadably engage with aperture threads 218 formed into the sidewall defining the lower end of the aperture 130 where it meets the rear surface 202. The lower end of such apertures 130 as shown herein is cylindrical which the upper end of the apertures 130 communicating with the front surface 201 which has an aperture sidewall formed with a counter sink angle outward from the axis of the apertures 130. This counter sink angle allows the head of the screws used through the apertures 130 which use screws to counter sink below the front surface 201. As such, the plug threads 216 are on a cylindrical portion of the plug 240 adjacent the second surface 208 thereof. Facilitating the coupling engagement of the plugs 240 with the aperture 130 is a recess 220 formed into the second surface 208. This allows the user to form the coupling of the plugs 240 in the apertures 130 necessary, by using a screw driver or similar tool through the aperture 130 where it communicates with the second side 202 of the hinge 100.

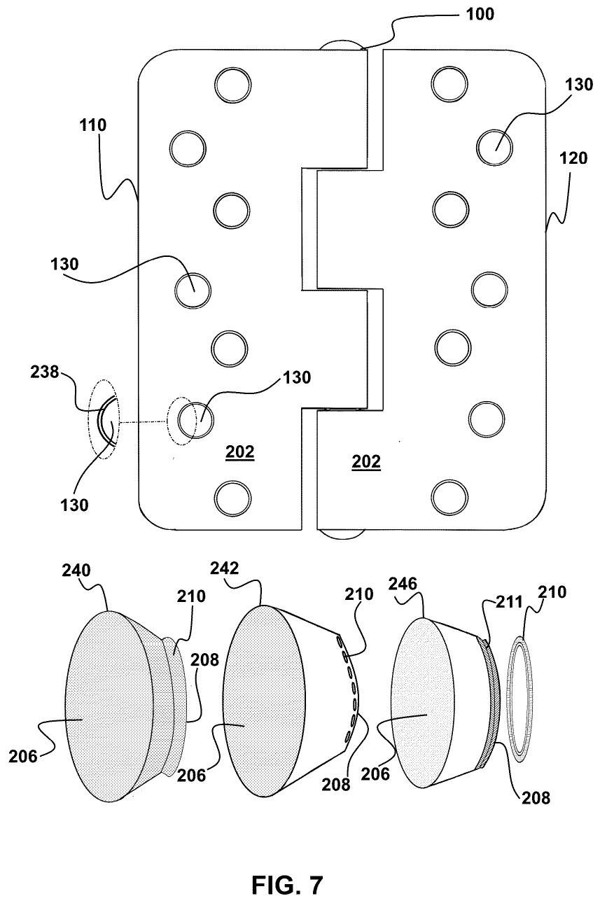

Another configuration of the replacement door hinge 100 and system herein is depicted in FIG. 7. Shown in FIG. 7 is a rear view of the rear surface 202 of both components of the formed door hinge 100. As shown, the apertures 130 are configured with recesses 238 at the intersection of the apertures 130 with the rear surface 202 and surround the aperture 130 where they are placed. This forms a recess 238 into the rear surface 202 of one or both of the door flange 110 and the frame flange 120.

Also shown in FIG. 7 are a plurality of differently configured plugs which are configured for coupled into the apertures 130 of the door hinge 100 shown in FIG. 7. All three of the plugs shown will form a coupling with a respective aperture 130 of the shown door hinge 100 using compressive coupling. By compressive coupling is meant that one of the plugs may be inserted into an aperture 130 from the front surface 201 thereof by pushing on a first surface 206 wherein a projecting annualar ring 210 formed of one or a plurality of projecting portions adjacent the second surface 208 will engage into to the recess 238. Such coupling may be by deflection or compression of the ring 210 while being forced through the aperture 130 toward the rear surface 202.

The annular ring 210 of the plug 240 is formed of a projecting metal or polymer portion engaged adjacent the second side 208 of the plug 240. The annular ring 210 of the plug 242 is formed of a plurality of spaced projections extending around the exterior surface of the plug 242. Finally the annular ring 210 of plug 246 is formed of a polymeric or soft metal material which engages within a slot 211 in the exterior surface. Other means to compressibly couple the plugs into apertures 130 may also be employed and are considered within the scope of the claims herein.

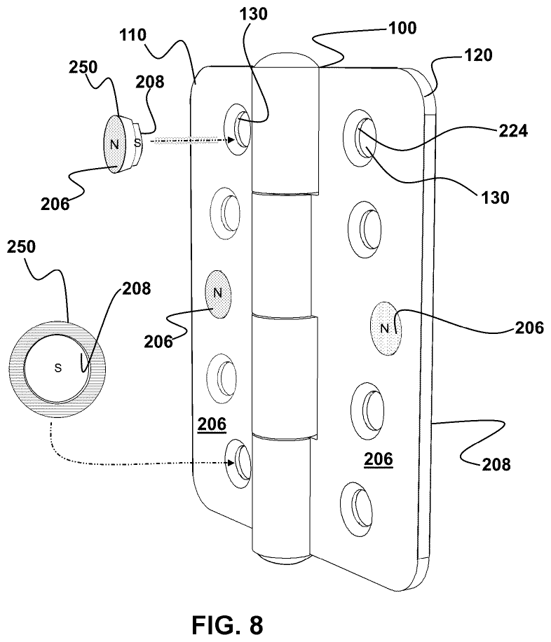

Another mode of the door hinge 100 device and system herein is shown in FIG. 8. In FIG. 8 is depicted the door hinge 100 of the system herein wherein the plugs 250 will form a coupling with the apertures 130 by magnetically coupling with the apertures 130 of the door hinge 100. In this mode the material forming the plugs 250 is magnetically attractive such as magnetized steel. Preferably the plugs 250 are magnetized with the same magnetic pole at a the first surface 206 which is the surface which will fill the opening to the apertures 130 which are visible once the door hinge 100 is engaged between a door and frame. This is preferred to cause opposing plugs 250 which may become close in proximity when the door is closed, to repel each other and help maintain the plugs 250 within the apertures 130. Also shown in FIG. 8, the circumferential exterior surface of the plug 250 adjacent the second surface 208 is cylindrical and has a diameter equal to or slightly smaller than the diameter of a cylindrical portion 224 of the aperture 130 to form a more secure coupling of the plug 250 to the hinge 100

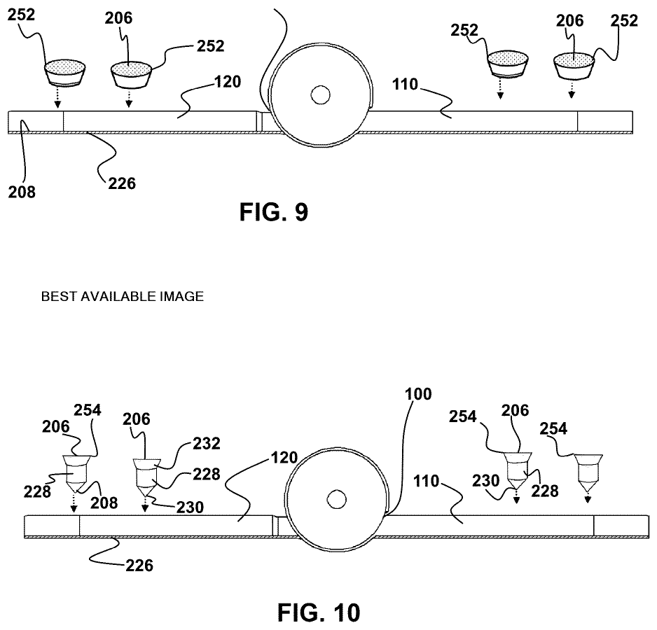

Another mode of the door hinge 100 device herein is shown in FIG. 9. As shown a, magnetic layer 226 is positioned upon the second surface 208 of one or both of the door flange 110 and frame flange 120. In this mode of the door hinge 100 device, the plugs 252 are configured for coupling with the apertures 130 by magnetic coupling. The magnetic coupling is formed by the magnetic layer 226 (such as the material forming a refrigerator magnet) positioned on the second surface 208 which attracts the plugs 252 which are formed of magnetically attractive material, such as steel. As with the other modes herein, the first surface 206 of the plug 252 is formed to appear substantially indistinguishable from the adjacent front surface 201 material. This may be accomplished using the same material for plugs and hinges 100 or by using polymers or coatings on the first surface 206 of the plug which match the appearance of the front surface 201 of the hinge 100.

Shown in FIG. 10 is a mode of the door hinge 100 herein having the plugs 254 configured in a longer axial length as dowels. The plugs 254 in this configuration are sized with a cylindrical portion 228 with an exterior circumference which is equal too or sightly smaller than an interior wall circumference of a cylindrical portion 224 (FIG. 8) of the aperture 130. Preferably the plugs 254 are formed of magnetic material such as magnetized steel to form a coupling engagement with the apertures 130 when inserted therein. In this case the coupling engagement is magnetic. For increased magnetic coupling the magnetic layer 226 may also be positioned on the second side 208 as in the door hinge 100 of FIG. 9.

By forming the circumference of the cylindrical portion 228 to be equal to or slightly smaller than the circumference of the cylindrical portion 224 of the aperture 130, it will have a tendency to frictionally engage within a hole in the door or frame which is stripped and unused for screws to add more shear strength to the coupling of the hinge 100 to the door and frame. Further, the length of the cylindrical portion 228 while shown slightly larger than the width of the door flange 110 and the frame flange 120, it can be longer to act as a nail when driven into the door or frame and can have ribs or the like on the exterior surface thereof to aid in maintaining a grip when driven into wood. Also, the pan head or countersink portion 232 provides a larger target for impact of a hammer thereon to allow the user to drive the magnetic plugs 254 to force the cylindrical portion 228 into the unused hole, or in some cases to provide extra engagement by forcing the cylindrical portion 228 into the undrilled wood of a door or door frame.

All modes of the door hinge 100 system herein may be provided in combination in a package which includes a reference card 250. Each such reference card 250 may be customized to bear reference holes 252 in various hole patterns that correspond to the hinge 100 accompanying the reference card 250. Further, the perimeter edge 254 of each reference card may be formed to mirror the shape of the perimeter edge of one or both of the frame flange 120 and door flange 110 which will allow the user to match the two edges to position the reference card 250 in a measuring position wherein the user can mark the door or frame with positions for new holes therein for screws communicated through the apertures 130 in the pattern matching the pattern of the reference hoes 252 on the reference card 250. In use, the user may place the reference card 250 to align with the position of the previous door hinge to ascertain which holes in the door or frame aligning with the reference holes 252 are not useable. They can use other reference holes 252 to mark new positions on the door or frame where new screws will be used to engage the wood thereof to the hinge 100. Thereafter, they may drill pilot holes using the marked new positions on the door or frame previously positioned thereon.

The user may then engage the door flange 110 to the door and the frame flange 120 to a door frame surrounding the door, using a combination of existing holes in the door or frame which are useable and the new holes at the new positions which were marked using the reference card 250. Once the door hinge 100 is operatively engaged between the door and hinge, the appropriate plugs may be positioned in apertures 130 where a screw has not been placed. In the configuration where the coupling of the plugs to the apertures 130 requires screwing from the side of the rear surface 202, the user may couple the plugs into the apertures 130 which will not have a screw therein before mounting the door flash 110 or frame flash 120 to the door or frame.

It should be noted that the plugs noted above with multiple numerical identifiers may be provided in combination with a door hinge 100 of the invention in a kit of a plurality of plugs which will be stuffiest to form couplings with some or all of the apertures 130 of the hinge 100 which the plugs accompany. By such a plurality of plugs herein is meant at least two and a maximum number in the plurality which equals the total aggregate number of apertures 130 in the door hinge 100 provided with the plurality of plugs.

It should also be noted as to the method in FIG. 5, that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for door hinge installation, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A door hinge comprising:
a door flange;
a frame flange; said frame flange pivotally coupled to said door flange;
a first plurality of apertures disposed on said door flange;
a second plurality of apertures disposed on said frame flange;
a plurality of plugs, each of said plurality of plugs having a first surface opposite a second surface;
each of said plurality of plugs configured to couple with all of said first plurarity of apertures and said second plurarity of apertures, whereby apertures from said first plurality of apertures not having fastners therethrogh engaging said door flange may be coupled to a plug and apertures from said second plurality of apertures not having fasteners therethrough engaged with said frame flange may be coupled to a plug.
